(19) United States
(12) Patent Application Publication
(10) Pub. No.: US 2011/0139089 A1
(43) Pub. Date: Jun. 16, 2011

(54) Safety Walking Rope for Plurality of Children

(75) Inventors: Robyn Spritzer, West Orange, NJ (US); Susanne Budofsky, Sparta, NJ (US)

(73) Assignee: GREATER THAN ONE KIDS, LLC, Fairfield, NJ (US)

(21) Appl. No.: 12/634,813

(22) Filed: Dec. 10, 2009

(51) Int. Cl. B60R 22/10; A01K 27/00; A44B 13/02

(52) U.S. Cl. 119/770; 119/795; 119/771; 24/601.5

(57) ABSTRACT

Embodiments of the disclosed technology include a device and method for training children to walk near their parents and encouraging children to do same. A carabiner is connected to a first strap, such as a wrist strap, as well as one or a plurality of handle straps. Each handle strap comprises, or is operatively connected to, a respective handle. The handle strap is removably engaged with the carabiner. That is, handle straps may be added or removed at will to change the number of straps attached to the carabiner or other connecting mechanism. In this manner, a parent may hold onto one strap (or attach such a strap to another device such as a stroller or backpack and instruct a plurality of children to walk with him or her.

### FIELD OF THE DISCLOSED TECHNOLOGY

The disclosed technology relates generally to child training devices, and more specifically, to devices for directing walking children.

### BACKGROUND OF THE DISCLOSED TECHNOLOGY

Herding young children safely is a problem well known to parents. Psychologists note that a normal child only listens to a command from a parent about 50% of the time. When walking with a child or children in a public area, this may translate into danger or a stressful parental situation. While some children are content in a stroller for an extended period of time, most children desire independence and the ability to walk rather than ride. At these times some children may huddle close to their parents, others are prone to wander off, or if not wander off, at least move too far away from their parent(s). When strangers move into a space between the parent and the child, this tends to make parents uneasy, and for very good reason.

When walking with one young child, it is easy enough to hold the child's hand. However, there will be times when the child may not want to hold the adult's hand or to walk. The adult's hands might also be holding other children's hands, packages and the like, or be pushing the stroller making it very difficult to physically direct a child. When walking with two children, the situation becomes exponentially harder, as one child may antagonize the other. Hands need to multi-task and, while tracking one child, one must not take one's eyes off the other child, and a “compliant” child may decide not to comply because the other child is not doing so. When walking with three children, the difficult situation is now raised to the third power. Pity the parent who has three young children pulling in and/or running off in three different directions.

The problem of walking with children has been dealt with in the prior art. For example, harnesses are known which attach around the torso or other body part of a child. The parent holds on to one end of a rope, in much the same way that a dog walker holds on to a leash. Of course, not everyone wants to put a child on a socially unacceptable leash-like product; in addition, multiple children require multiple leashes and can still pull in all sorts of different directions, causing tangling and a frustrated parent. This method also adds little to the training of a child to stay near the parent. There are walking ropes in the marketplace designed for classroom like situations where a caregiver holds the front of the device and 6 to 12 children trail in a line behind the adult. This configuration is ideal only in limited circumstances, e.g. for caregivers walking with many, many children, such as with a class.

What is needed is a device or method for walking with youngsters, especially in the case of more than one child, without having to actually restrain them and without having to worry about tangling of children or devices, and at the same time promote the children's listening and walking skills.

### SUMMARY OF THE DISCLOSED TECHNOLOGY

It is therefore an object of the disclosed technology to train children to walk near their parents (where ‘parent’ may be any one of an adult, older child, or guardian, or caretaker).

It is a further object of the disclosed technology to provide a device adapted for walking with a plurality of children.

It is a further object of the disclosed technology to provide such a device with safety releases and tangling prevention.

An embodiment of the disclosed technology includes a kit with a carabiner, a strap removably engaged with the carabiner, and a plurality of handle straps each operatively attached to a respective handle. Each handle strap is removably engageable with the carabiner, allowing for the addition of many, such as three, straps to the carabiner. The carabiner may be kept at a variable distance away from a person, stroller, or other device under the operative control of a person (such as a parent) due to the strap between the person or stroller and the carabiner. Two, three, four, or more handle straps may be used, and one child may hold on to each handle strap. The handle straps are adjustable in length (e.g. to a length of an arm of a parent), may be rigid, and may have a safety release at a central portion thereof, so that a strap can be released, not only at the carabiner, but somewhere within the strap itself, in case of tangling or other emergency. The carabiner may be D-shaped.

A method for walking with children, in an embodiment of the disclosed technology, proceeds by attaching a strap to a device under direct operative control of a parent. Such a device, may for example, be a stroller or hand of the parent. A plurality of handle straps are attached to the strap under the operative control of a parent by way of a carabiner. Each handle strap of the plurality of handle straps is pre-attached to a handle, and a child is instructed to hold on to a handle. In this manner, one, two, three, four, or more children will find it enjoyable and empowering to hold onto something while being trained to walk near a parent (or other adult).

Each handle strap may be separately adjustable and the length of a handle strap might be the arms length of the parent, so that the parent may easily reach a child in the event of an emergency or misbehavior, and if necessary, detach a handle from the carabiner using a safety release. Likewise, the features of the device of the disclosed technology above may be incorporated into the method.

Another device of the disclosed technology, a device for managing a plurality of children, has means for strapping a first end of a device under the direct operative control of a parent, means for allowing a plurality of second ends to rotate relative to the parent while retaining the relative position of the first end with respect to the parent, and a plurality of handle means, wherein each handle means is adapted for graspable engagement by a child. Such a device under the direct operative control of a parent may be a stroller or parent him/herself, and the device of the disclosed technology is removably attached to the stroller or parent. The methods or devices disclosed above may be combined with, or form some of, the means disclosed herein.

### BRIEF DESCRIPTION OF THE DRAWINGS

FIG. 1 shows a device of embodiments of the disclosed technology being used in a method thereof.

FIG. 2 shows a wrist strap and a plurality of hand straps of embodiments of the disclosed technology.

FIG. 3A shows a side view of a wrist strap with carabiner used in embodiments of the disclosed technology.

FIG. 3B shows a front view of the devices of FIG. 3A.

FIG. 3C shows an opposite side view of the devices of FIG. 3A.

FIG. 4A shows a side view of a hand strap with handle used in embodiments of the disclosed technology.

FIG. 4B shows a front view of the devices of FIG. 4A.

FIG. 4C shows an opposite side view of the devices of FIG. 4A.

FIG. 5 shows a handle used in embodiments of the disclosed technology.

FIG. 6 shows a complete kit of embodiments of the disclosed technology with a single hand strap and handle.

FIG. 7 shows a complete kit of embodiments of the disclosed technology with a plurality of hand straps and handles.

FIG. 8 shows a detail of a user holding a wrist strap connected to a carabiner and plurality of hand straps in an embodiment of the disclosed technology.

FIG. 9 shows a detail of a wrist strap attached to a stroller and connected to a carabiner and plurality of hand straps in an embodiment of the disclosed technology.

### DETAILED DESCRIPTION OF EMBODIMENTS OF THE DISCLOSED TECHNOLOGY

Embodiments of the disclosed technology include a device and method for training children to walk near their parents and encouraging children to do same. The devices of the disclosed technology may be adapted for any purpose, such as dog walking, hiking with adults or children, ski lessons, parade walking formations, and any other walking need where multiple parties must stay together or stay at predefined distances from one another. For purposes of this disclosure, a parent may not only be a biological parent, but may be any legal guardian, caregiver, adult, older sibling, or the like, who is guiding the walking location of others. A child may be any person under the age of 10, or alternatively, any person or thing grasping the handle of embodiments of the disclosed technology.

Devices of the disclosed technology comprise a carabiner or any other connecting mechanism (e.g., ring, interlocking loops, ties, or the like) which is connected to a first strap, such as a wrist strap, as well as one or a plurality of handle straps. Each handle strap comprises or is operatively connected to, a respective handle. The handle strap is removably engaged with the carabiner. That is, handle straps may be added or removed at will to change the number of straps attached to the carabiner or other connecting mechanism. In this manner, a parent may hold onto one strap (or attach such a strap to another device such as a stroller or backpack) and instruct a plurality of children to walk with him or her.

Embodiments of the disclosed technology will become clearer in light of the following description of the figures.

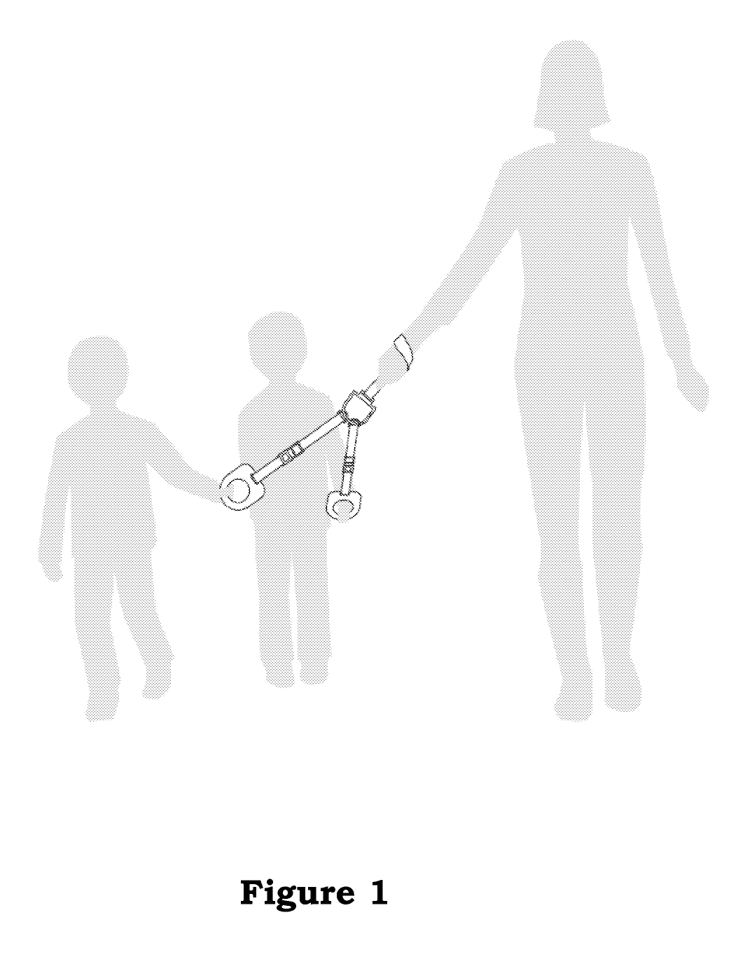

FIG. 1 shows a device of embodiments of the disclosed technology being used in a method thereof. While the device and method of use will be described in more detail herein below, FIG. 1 shows a woman walking with two children. She has a strap around her wrist which is operatively connected (pre-attached) to a carabiner. This particular carabiner is D-shaped, though carabiner of any shape, or any ring or other connection mechanism, such as one which provides a slidable connection to another device, may be used in embodiments of the disclosed technology. Handle straps, such as one, two, three, four, or five straps are attached to the carabiner and comprise an emergency disengagement switch or mechanism somewhere along the handle strap, such as in the middle, to allow for disconnection of a handle strap at a location along the strap in case of emergency, tangling with other objects, or the like. A handle is attached at the end of the handle strap and a child may be instructed to hold on to the handle. The handle can be a toy or something else that the child likes to hold onto. In this manner, the child is not restrained, but is rather encouraged to walk with the parent in a fun way. Each child may have his particular handle with indicia for recognition thereof by the child, such as a color, shape, logo, or device to hold onto. A child's stuffed animal, for example, might be attached to a handle strap, so the child merely holds on to his stuffed animal, as he or she is used to doing, only it is also attached by way of the other devices to a parent or stroller to ensure the child stays nearby.

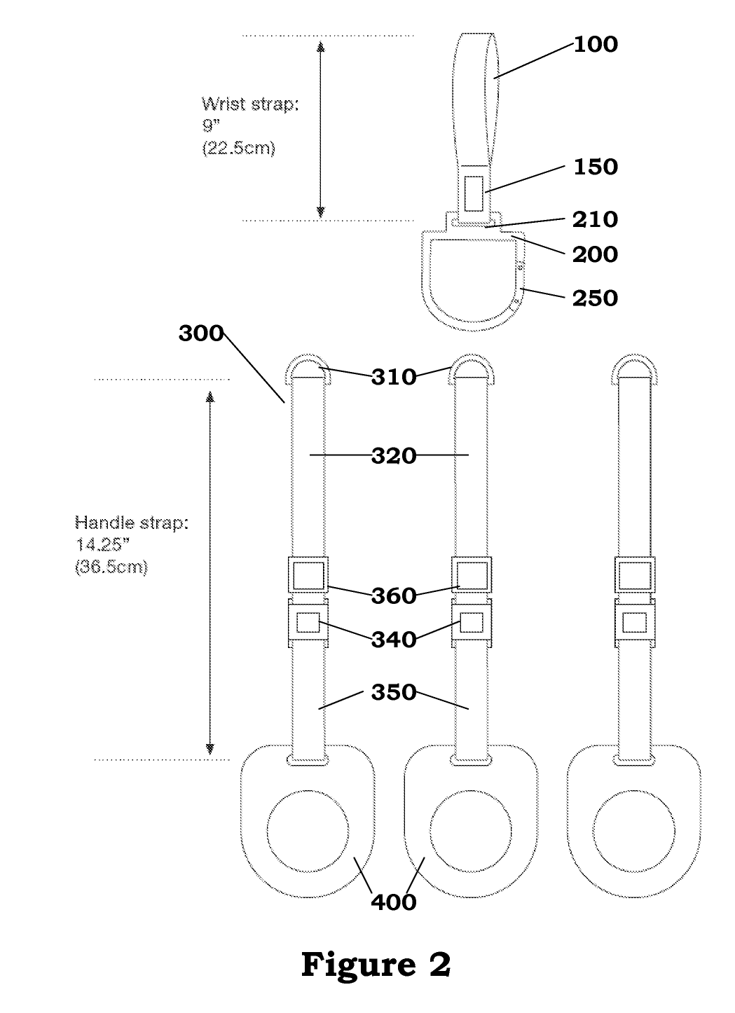

FIG. 2 shows a wrist strap and a plurality of hand straps of embodiments of the disclosed technology. A wrist strap 100, in an embodiment thereof, may be 9 inches long or any length desired by a user or manufacturer of same, such as between 1 inch (e.g., a clip) and 24 inches. The wrist strap 100, in embodiments, is a closed loop terminating at a connector 150, where, for example, a logo may be placed. The connector 150, in embodiments of the disclosed technology is rigid or flexible. A flexible connector may be procured from nylon webbing. The connector 150 further provides connectors for a strap or a place for a strap to be looped through. Likewise, it attaches to a carabiner 200. In embodiments of the disclosed technology, the strap 100 may be attached directly to the carabiner 200. The strap, connector, and carabiner may each be rigid or flexible.

The carabiner 200, as shown in FIG. 2, may be D-shaped, that is, having a flat side, the ends thereof forming a unitary structure with a rounded side. This allows the flat side to be perpendicular to the wrist strap 100 and the rounded side to allow curvilinear movement about a parent by children engaged with straps. A carabiner opening 250 may also be employed allowing for a separation of the D-shaped portion of the carabiner for addition or removal of a hand strap or direct attachment to a stroller. Keys, bags, or other items may also be attached to the carabiner.

The hand strap 300 (three are shown next to each other in FIG. 2) comprises, in embodiments of the disclosed technology, a connecting loop 310 which operatively engages with the carabiner 200 a first portion 320 of the hand strap 300. The hand strap length is adjustable, in embodiments of the disclosed technology. For example, the strap length may be adjusted to between 3 or 4 inches to 14.25 inches to provide maximum parental control with customizable height and arm's length. The material of 320 is looped through an adjustable buckle 360 that allows for this adjustability. A safety release 340 connects a first portion 320 and second portion 350 of the hand strap and allows for disconnection of the lower portion (second portion) from the upper (first portion). A handle 400 is attached to the lower second portion 350. The hand strap 300 may comprise flexible and/or rigid elements in any configuration.

Referring still to FIG. 2, in embodiments of the disclosed technology, the wrist strap 100, connector 150, and carabiner 200 are pre-attached and are not readily disengageable (meaning, a multi-step or time-consuming process is required for disconnection of such items). Similarly, the connector 310 and first portion 320 of the hand strap 300 are pre-attached, along with the safety release 340, the adjustable buckle 360 and second portion 350 of the hand strap 300, though the safety release is readily disengageable for safety reasons. So too, the handle 400 is pre-attached and not readily disengageable from the second portion 350 of the hand strap 300. In this manner, a parent may easily add or remove hand straps 300 to a carabiner 200 and efficiently reconfigure the device as the number of children holding on to the device changes. Reconfiguration of a type requiring a change in the wrist strap 100 to another or change of a handle 400 may still be possible for a user without irreversibly causing damage to the device, in embodiments of the disclosed technology, but requires a more time-consuming or multi-step process, as such connections are meant to be semi-permanent (last over multiple usages of the device).

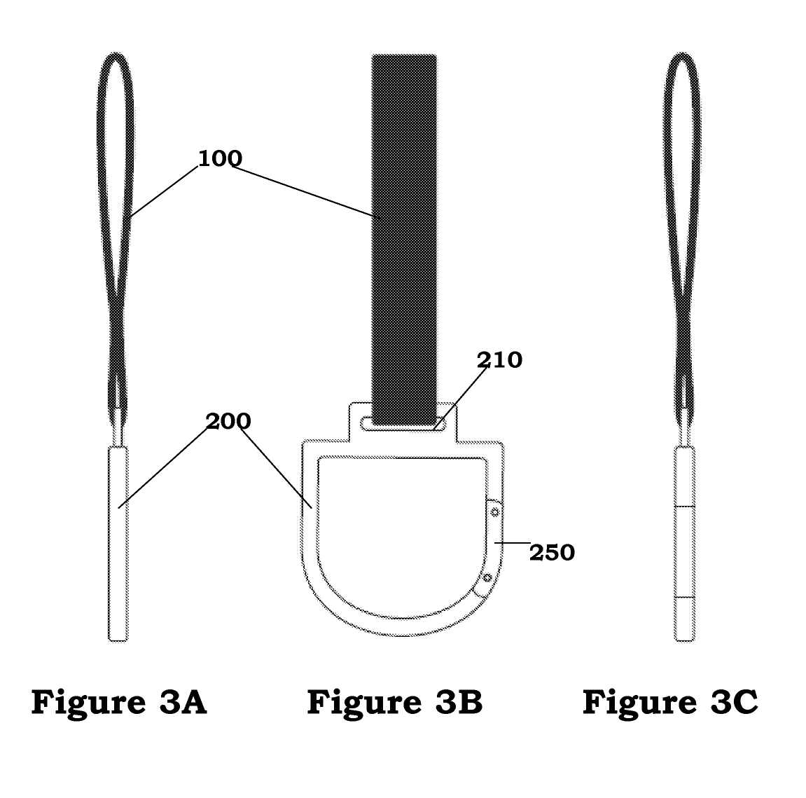

FIG. 3A shows a side view of a wrist strap with carabiner used in embodiments of the disclosed technology. FIG. 3B shows a front view of the devices of FIG. 3A. FIG. 3C shows an opposite side view of the devices of FIG. 3A. The wrist strap 100 is any sort of strap, connector, fabric loop, rigid handle with an aperture there-through, or the like. The carabiner 200 is any sort of ring, such as a D-shaped ring, O-shaped ring, or even a bar with stops at each end to keep connectors operatively connected to it. A portal 210 may be comprised therein for attachment of a wrist strap 100, or a connector may be placed thereon, such as for engagement with a corresponding connector of the wrist strap 100. The carabiner 200 comprises an opening, in embodiments of the disclosed technology, to allow for the addition or removal of a hand strap or potentially direct attachment to a stroller. In other embodiments, the hand straps have connecting mechanisms (such as openings like those shown on the carabiner in FIG. 3B) for attachment to the carabiner 200.

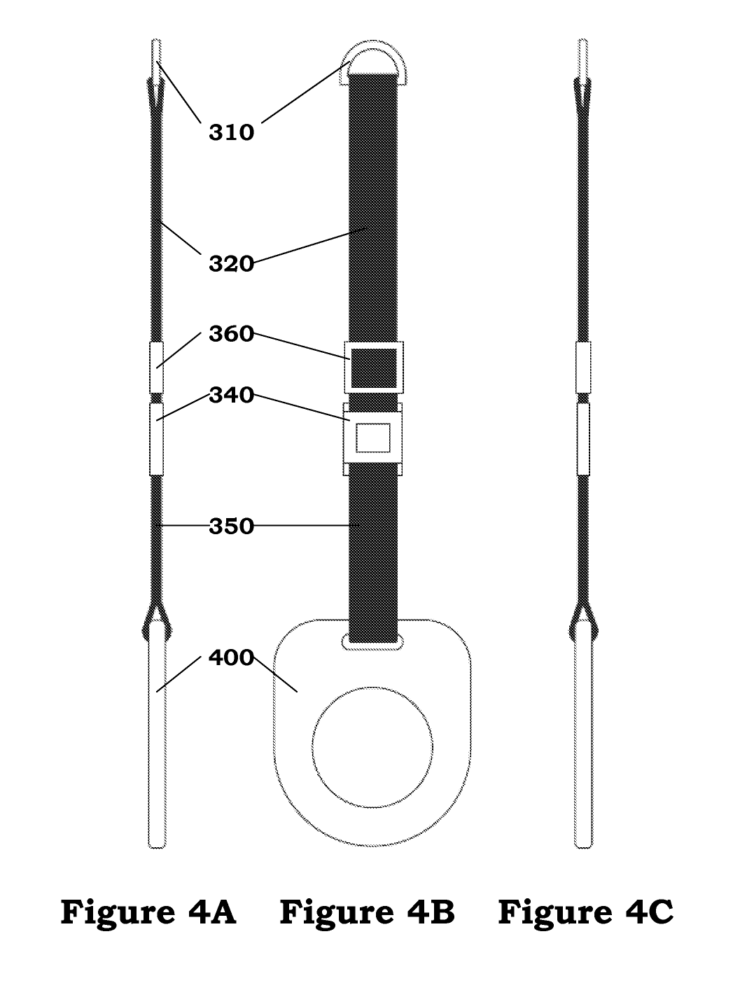

FIG. 4A shows a side view of a hand strap with handle used in embodiments of the disclosed technology. FIG. 4B shows a front view of the devices of FIG. 4A. FIG. 4C shows an opposite side view of the devices of FIG. 4A. The handle 400 is attached, such as by way of pre-attachment, to a lower portion 350 of a handle strap 300. A safety release 340 connects the lower portion 350 with an upper portion 320 of the handle strap and a connector 310 is pre-attached to the upper portion 320. The upper portion of the handle strap 320 is permanently looped through the adjustable clip 360, in an embodiment of the disclosed technology. The connector 310 operatively engages with/connects to a carabiner 200 and may be D-shaped as shown or round. The length of the handle strap 300 may be adjustable by way of a adjustable buckle 360 which doubles up a portion of the fabric used in the handle strap to decrease or increase the length. The safety release 340, in embodiments of the disclosed technology, has a depressable button on the front or side which, when pressed, separates the upper and lower portion of the handle strap 300 from each other and rapidly disengages a child holding the handle 400 from the carabiner 200, such as in a case of emergency, tangling, or the like. The handle strap 300 may be flexible or rigid. The length may be predefined/customized by a parent, such as to keep a child within a certain distance from the parent.

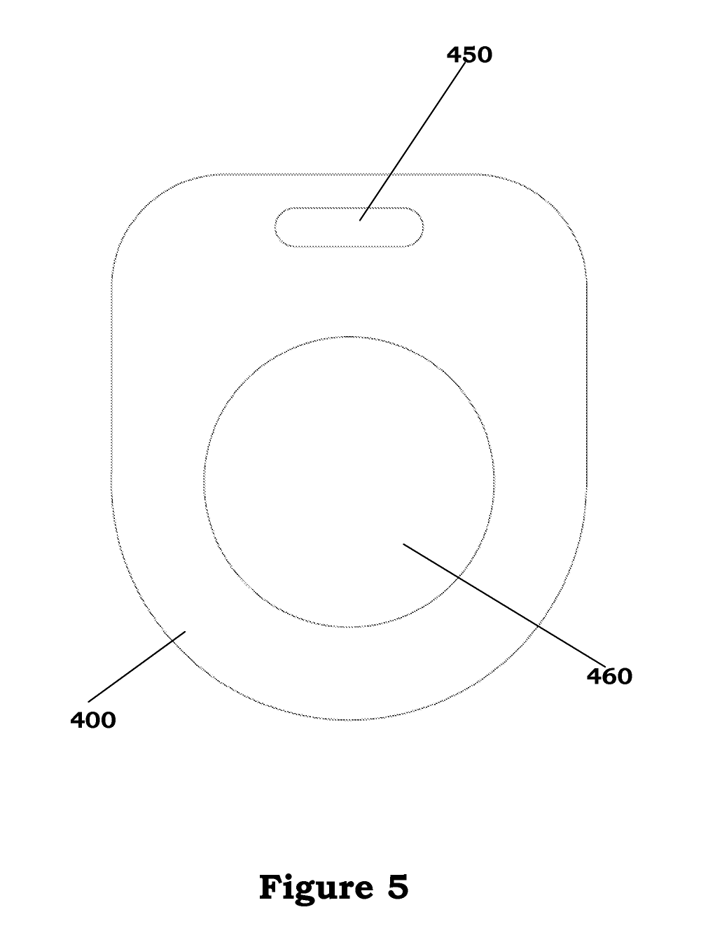

FIG. 5 shows a handle used in embodiments of the disclosed technology. The handle may be a child's toy, may vary in color, size, shape, or feel. All the handles of a plurality of handles employed at a time when using devices of the disclosed technology, such as multiple handles attached to a single wrist strap 100 and/or under the control or partial control of a single parent, may vary from one another by one or a plurality of the variation means described above (color, size, etc.). In the embodiment of the handle shown in FIG. 5, the handle comprises a connection aperture 450 for engaging a hand strap therein for removable, pre-attached, connection thereto. A grasping aperture 460 allows for easy graspable engagement by a child, so that such a child may hold on to the device while being “led” by a parent. A handle of any shape, such as those attractive to a child, may be used.

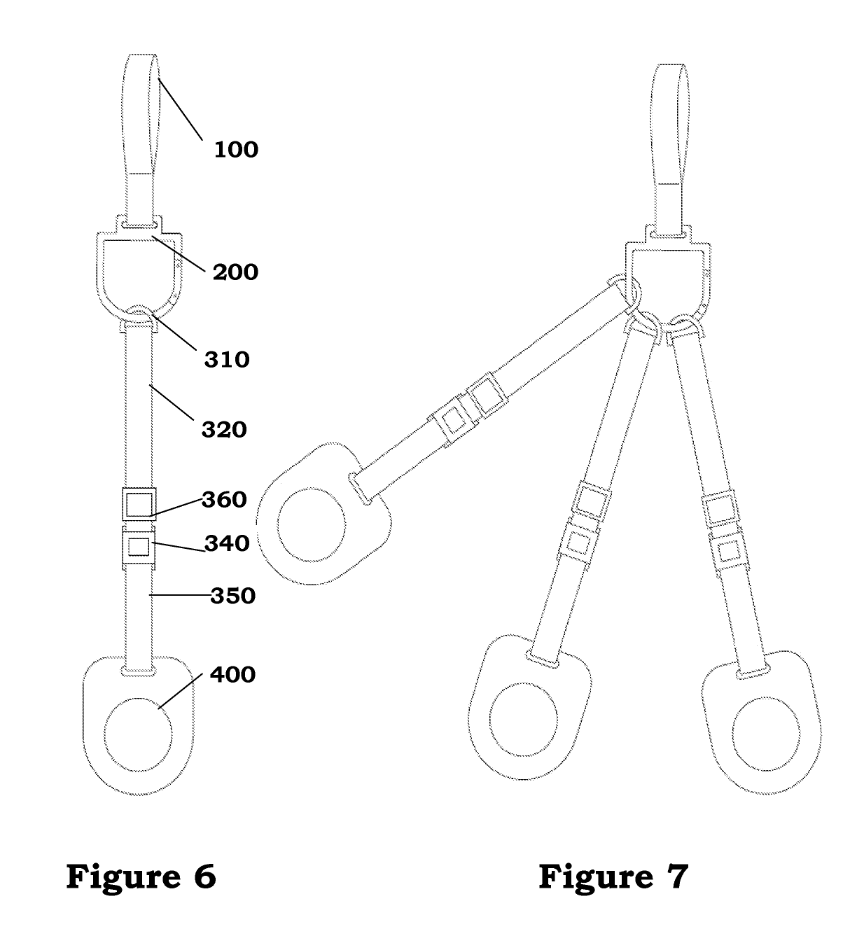

FIG. 6 shows a complete kit of embodiments of the disclosed technology with a single hand strap and handle. In FIG. 6, where a single handle is attached, the handle 400, is attached to a lower portion 350 of a handle strap 300, the strap further comprising a safety release 340 and upper portion 320. In embodiments of the disclosed technology, the upper and lower portions may be a unitary piece, and the safety release 340 as well as the adjustable buckle 360 may be left out of the structure of the device. A connector 310 of the hand strap 300 attaches to a carabiner 200 or other connecting mechanism, allowing for rotatable engagement of the hand strap 300 with the wrist strap 100. In the embodiment shown, the connector 310 is attached to the carabiner 200 by way of passing a portion of the ring of the carabiner 200 through the loop of the connector 310.

FIG. 7 shows a complete kit of embodiments of the disclosed technology with a plurality of hand straps and handles. For clarity of the drawings, the elements of FIG. 7 have not been numbered but are repetitious of those elements shown in FIG. 6 and other figures. Here, a plurality of handle straps with corresponding handles (in this case, identical handles) have been removably attached/engaged with an attachment mechanism, a carabiner, which is in turn pre-attached to a wrist strap. In this manner, a parent, for example, may walk with a plurality of children. Each child holds on to one of the handles, and each handle is pre-attached to a handle strap (that is, attached before a child grabs a handle/before usage of the device for walking with children). Each child is instructed to hold on to a separate handle.

Now, with the positive reinforcement and feeling of connection with their parent, the children have something to hold on to, grasp, and stay connected with their parent, while the parent can walk forward and is alerted when a child lets go or tugs in a direction contrary to the movement. Still further, with “group thinking” mentality, much like where one husky sled dog will pull in any direction it pleases but a team of sled dogs walk together in the direction that you direct them to, a group of children walk together when holding on to various handles. The children feel they have control (they can release their grip at any time), and the parent has substantially freed up his or her hand and mind to be occupied with other things, thus making the parent's and children's travels more efficient and less tiresome, both physically and emotionally. In short, the device shown in FIG. 7 makes a family more able to cope. In the case that a child voluntarily releases the handle at an inappropriate time, it is up to the parent to decide if the child's independence must be curbed.

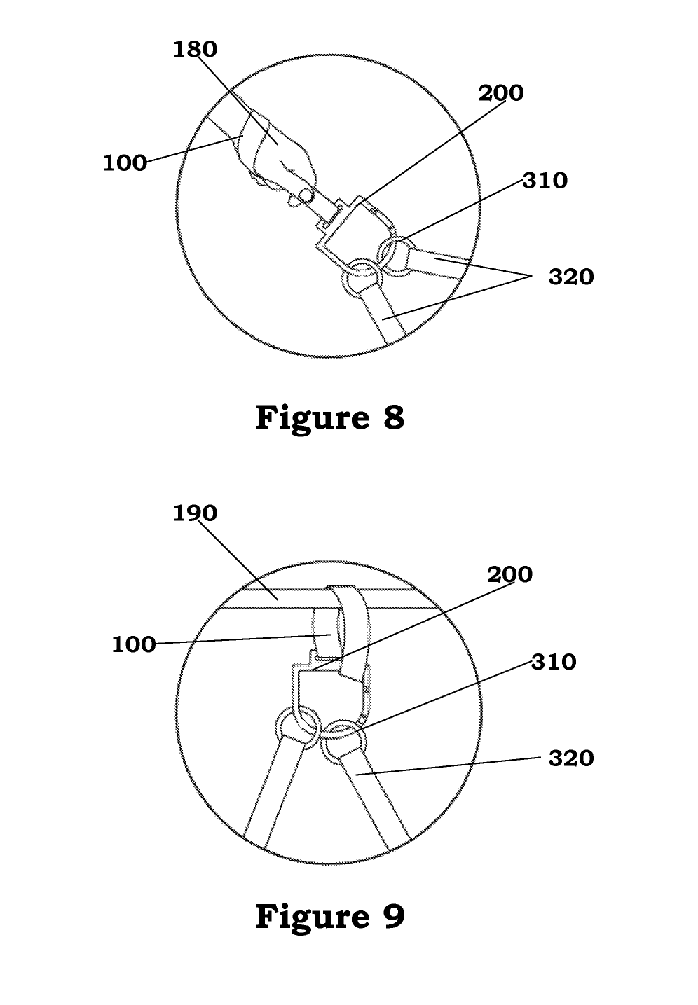

FIG. 8 shows a detail of a user holding a wrist strap connected to a carabiner and plurality of hand straps in an embodiment of the disclosed technology. In the embodiment shown, the user, such as a parent with a hand 180 wraps the wrist strap 100 around his or her hand or wrist and grasps the wrist strap 100. Several handle straps 300, as shown, are attached to a carabiner 200, allowing the parent to pull, direct, or guide as many children as desired.

FIG. 9 shows a detail of a wrist strap attached to a stroller and connected to a carabiner and plurality of hand straps in an embodiment of the disclosed technology. Here, the wrist strap 100 is looped around a portion of a stroller 190. The wrist strap 100, in such an embodiment, may comprise a connector, such as snaps, male/female interlocking straps, a hook, a closable hook, or the like, to allow for easy attachment and detachment of the wrist strap to a stroller or other device. (Some strollers may allow for the carabiner to directly snap onto the stroller with out the need for the handle strap interlocking.) The wrist strap 100 may be a loop, as shown in the figures, and a person may attach the loop to a stroller or other device by passing the device itself around a stroller piece and through the loop in such a manner as to knot the strap around the stroller portion 190. In this manner, the parents' hands are free. In an example thereof, supposing a parent with children of ages 6, 5 and 1 uses the device while walking through an amusement park. The wrist strap 100 is kept attached to a stroller in which the 1 year old sits, and the 6 and 5 year olds each grab a handle 400 attached to the wrist strap and, ultimately, the stroller. The parent now needs only to push the stroller to “move” (or herd) all three children. Meanwhile, the parent is mobile and free to let go, grab a ringing phone in his/her pocket, and so forth. If two parents are walking together, one parent is now completely free to do other things, and the children, can be kept on one side of the stroller by way of the direction of the hand straps relative to the stroller, and the other parent is free to walk next to the stroller-pushing parent with much less fear of tripping over or running over a child.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

We claim:

1. A kit comprising:
a carabiner,
a strap removably engaged with said carabiner, and
a plurality of handle straps each operatively attached to a respective handle,
wherein each handle strap is removably engageable with said carabiner.

2. The kit of claim 1, wherein said plurality of handle straps is comprised of three handle straps.

3. The kit of claim 2, wherein said three handle straps are each removably attached to said carabiner.

4. The kit of claim 1, wherein said strap is held by a person.

5. The kit of claim 1, wherein said strap is removably attached to a stroller.

6. The kit of claim 1, wherein each said handle is held by a child.

7. The kit of claim 6, wherein the length of each said handle strap is adjustable.

8. The kit of claim 1, wherein said carabiner is a D-shaped carabiner.

9. The kit of claim 1, wherein at least one handle strap is rigid.

10. The kit of claim 9, wherein said handle straps comprise a safety release at a middle portion of said handle strap.

11. A method for walking with children comprising:
attaching a strap to a device under direct operative control of a parent;
attaching at least one handle strap to said strap by way of a carabiner situated there-between, wherein each handle strap of said plurality of handle straps is pre-attached to a handle, and
instructing said children to each hold on to a separate said handle.

12. The method of claim 11, wherein said device under direct operative control of a parent is a hand of said parent.

13. The method of claim 11, wherein said device under direct operative control of a parent is a stroller.

14. The method of claim 11, wherein the length of each said handle strap is separately adjustable and said length comprises within an arm's length of said parent.

15. The method of claim 14, wherein said plurality of handle straps is three handle straps.

16. The method of claim 11, wherein said carabiner is a D-shaped carabiner.

17. The method of claim 11, wherein said straps are rigid.

18. The method of claim 11, wherein said parent disconnects a said strap at a central location thereof using a safety release upon said parent determining that an unsafe condition has occurred.

19. A device for managing a plurality of children comprising:
means for strapping a first end to a device under the direct operative control of a parent;
means for allowing a plurality of second ends thereof to rotate relative to said parent while retaining the relative position of said first end with respect to the parent; and
a plurality of handle means, wherein each said handle means is adapted for graspable engagement by a child of said plurality of children.

20. The device of claim 19 wherein said device under the direct operative control of a parent is a stroller and said device of claim 19 is removably attached to said stroller.

21. The device of claim 19, wherein said device under the direct operative control of a parent is a body part of said parent.

22. The device of claim 19, wherein each handle of said plurality of handles is adjustable in length.

23. The device of claim 19, wherein said plurality of handle means is three handle means.

24. The device of claim 19, wherein at least two children are graspably engaged with a said handle.

25. The device of claim 19, further comprising disconnection means within said strap for use in an emergency situation.
